(19) United States
(12) Patent Application Publication
(10) Pub. No.: US 2025/0108796 A1
(43) Pub. Date: Apr. 3, 2025

(54) METHOD FOR OPERATING AN AUTONOMOUS VEHICLE

(71) Applicant: Torc Robotics, Inc., Blacksburg, VA (US)

(72) Inventors: Carlo Elwinger, Maulbronn (DE); Fridtjof Stein, Ostfildern (DE); Chaitra Ashok Reddy, Bietigheim-Bissingen (DE)

(21) Appl. No.: 18/899,398

(22) Filed: Sep. 27, 2024

(30) Foreign Application Priority Data
Sep. 29, 2023 (DE) 102023126734.5

(51) Int. Cl. B60W 30/09; B60W 10/20; B60W 30/095; B60W 30/14; B60W 60/00

(52) U.S. Cl. CPC B60W 30/09; B60W 10/20; B60W 30/0956; B60W 30/146; B60W 60/0015; B60W 2300/12; B60W 2554/4023; B60W 2554/4045; B60W 2554/4049; B60W 2554/80

(57) ABSTRACT

A method for operating an autonomous vehicle includes detecting an environment of the autonomous vehicle using a sensor system, wherein data of the environment is made available to a computing unit, wherein the sensor system detects whether a second vehicle is attempting to overtake the autonomous vehicle. The method includes steering the autonomous vehicle laterally away from the second vehicle when oncoming traffic is detected, thereby creating sufficient space for the second vehicle and the oncoming traffic. The method includes detecting whether the second vehicle intends to overtake the autonomous vehicle. The method includes determining a speed differential between the second vehicle and the autonomous vehicle. The method includes implementing a defensive driving maneuver wherein the speed of the autonomous vehicle is reduced if the speed differential falls below a predetermined threshold value.

### CROSS REFERENCE TO RELATED APPLICATIONS

The present application claims priority to German Patent Application No. 102023126734.5, filed on Sep. 29, 2023, and titled “Method for operating an autonomous ego vehicle”, the disclosure of which is hereby incorporated by reference in its entirety.

### TECHNICAL FIELD

The present disclosure relates to a method for operating an autonomous vehicle, and particularly, a method for adjusting the speed of the autonomous vehicle in response to a second vehicle.

### BACKGROUND

Autonomous commercial vehicles will be driving on highways in the future. These vehicles will drive at a set speed in line with their environment. Sometimes there will be faster road users who carry out an overtaking maneuver. There are legal regulations governing the maximum time such an overtaking maneuver may take, for example.

US 2022/0324444 A1 describes a method for calculating a lateral position of an ego motor vehicle in a lane, comprising calculating a first theoretical lateral position of the ego vehicle, calculating a second theoretical lateral position of the ego vehicle, calculating a third theoretical lateral position of the ego vehicle, calculating the lateral position of the ego vehicle using a weighted average of the first lateral position, the second lateral position and the third lateral position.

The object of the present disclosure is to provide a novel method for operating an autonomous vehicle and a novel autonomous vehicle.

### BRIEF DESCRIPTION

In one aspect, a method for operating an autonomous ego vehicle includes detecting an environment of the autonomous vehicle using a sensor system, wherein data of the environment is made available to a computing unit, wherein the sensor system detects whether a second vehicle is attempting to overtake the autonomous vehicle. The method includes steering the autonomous vehicle laterally away from the second vehicle when oncoming traffic is detected, thereby creating sufficient space for the second vehicle and the oncoming traffic. The method includes detecting whether the second vehicle intends to overtake the autonomous vehicle. The method includes determining a speed differential between the second vehicle and the autonomous vehicle. The method includes implementing a defensive driving maneuver wherein the speed of the autonomous vehicle is reduced if the speed differential falls below a predetermined threshold value.

In another aspect, an autonomous vehicle includes a sensor system configured to detect an environment of the autonomous vehicle, wherein the sensor system is configured to detect whether a second vehicle is attempting to overtake the autonomous vehicle and a computing unit in electrical communication with the sensor system, wherein the sensor system is configured to provide the data of the environment of the autonomous vehicle to the computing unit. The autonomous vehicle is steered laterally away from the second vehicle when oncoming traffic is detected, thereby creating sufficient space for the second vehicle and the oncoming traffic. The autonomous vehicle is configured to determine a speed differential between the second vehicle and the autonomous vehicle. The autonomous vehicle is configured to implement a defensive driving maneuver wherein the speed of the autonomous vehicle is reduced if the speed differential falls below a predetermined threshold value.

The present disclosure provides a technical implementation for autonomous vehicles, for example autonomous commercial vehicles, which is used when the autonomous vehicle is overtaken and a long overtaking process is to be avoided. If the speed difference between an overtaking vehicle and the autonomous commercial vehicle is too small, the autonomous commercial vehicle should react proactively (longitudinally and/or laterally).

In a non-limiting example, the solution according to the present disclosure results in increased safety. Furthermore, it is believed that collisions may be avoided and confidence is may be created for other road users.

### BRIEF DESCRIPTION OF DRAWINGS

Exemplary embodiments of the present disclosure are explained in more detail below with reference to drawings.

### In Particular:

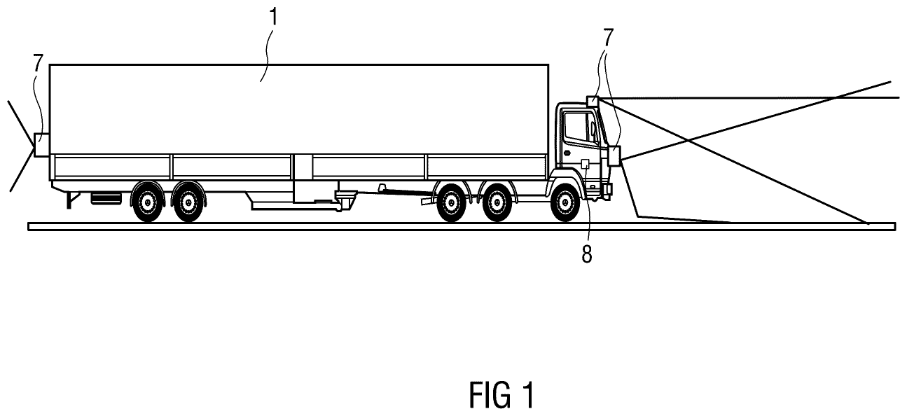

FIG. 1 shows a schematic view of an autonomous vehicle,

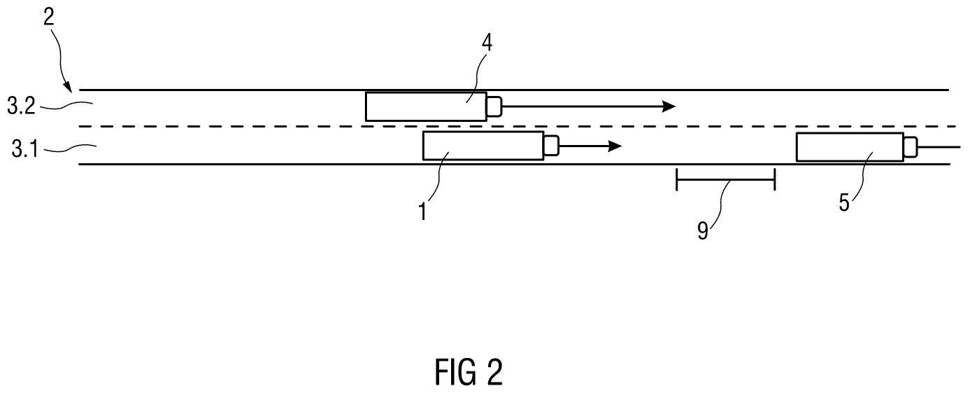

FIG. 2 shows a schematic view of a roadway with two lanes, wherein the autonomous vehicle drives in one of the lanes and an overtaking vehicle drives in the adjacent lane,

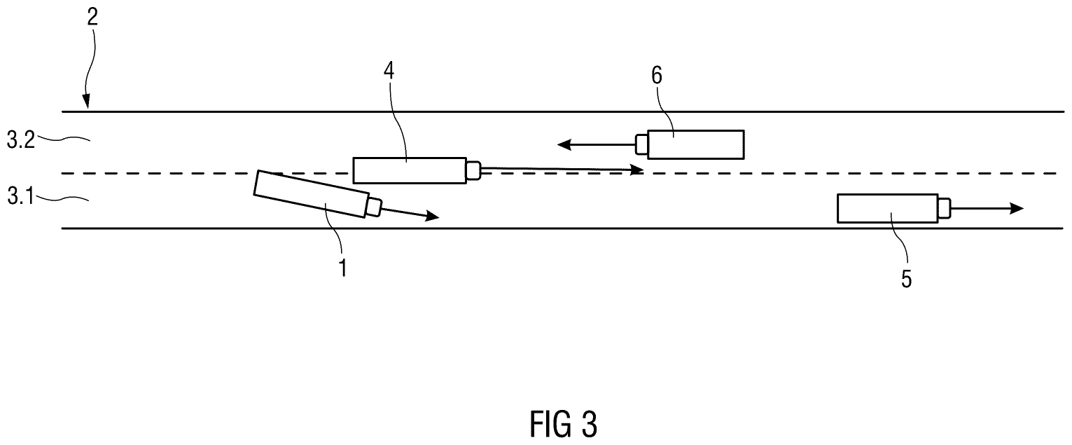

FIG. 3 shows a schematic view of a roadway with two lanes, wherein the autonomous vehicle drives in one of the lanes and is being overtaken by an overtaking vehicle, wherein an oncoming vehicle drives in the other lane,

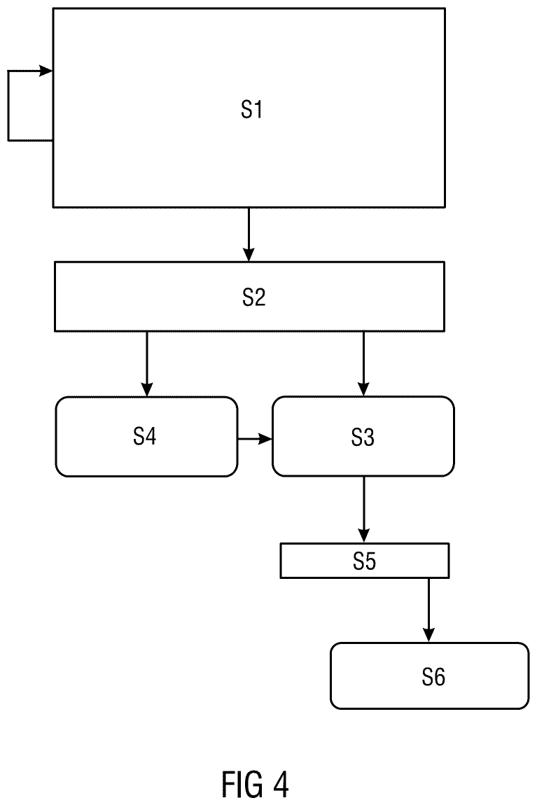

FIG. 4 shows a schematic view of a method for operating the autonomous vehicle, and

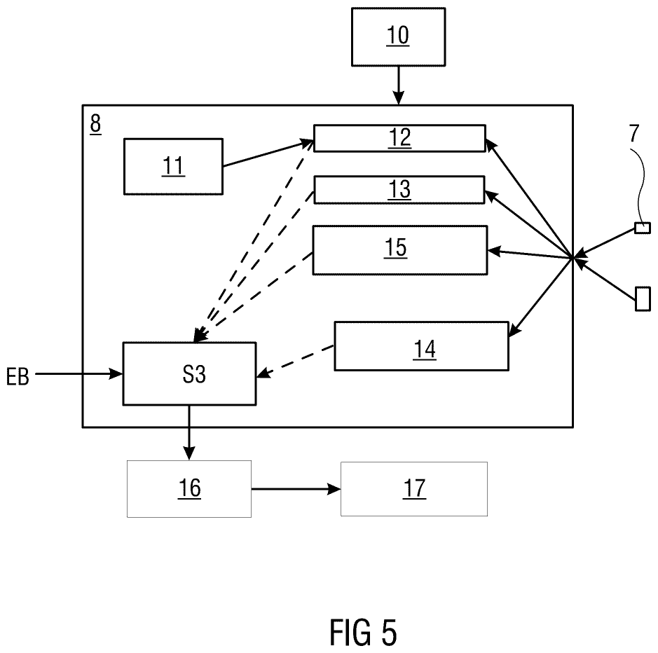

FIG. 5 shows a schematic view of a computing unit of the autonomous vehicle.

Corresponding parts are marked with the same reference signs in all figures.

### DETAILED DESCRIPTION

FIG. 1 is a schematic view of an autonomous vehicle 1, in particular a commercial vehicle.

The autonomous vehicle 1 has a sensor system 7 for detecting the environment of the autonomous vehicle 1, in particular in front of, behind and next to the autonomous vehicle 1 in the direction of travel. The sensor system 7 can, for example, have at least one camera and/or at least one radar sensor and/or at least one LIDAR sensor. The sensor system 7 can be coupled to a computing unit 8, which is configured to detect and track objects in the environment detected by the sensor system 7.

FIG. 2 is a schematic view of a roadway 2 with two lanes 3.1, 3.2, wherein the autonomous vehicle 1 is driving at a speed v_{ego} in lane 3.1 and wherein, in the adjacent lane 3.2, an overtaking vehicle 4, for example a passenger car, a motorcycle or a commercial vehicle, is driving at a speed VA that is greater than the speed v_{ego} of the autonomous vehicle 1, so that a relative speed vᵣₑₗ results as the difference between the speed VA of the overtaking vehicle 4 and the speed v_{ego} of the autonomous vehicle 1. A vehicle 5, for example a passenger car, motorcycle or commercial vehicle, is driving at a distance ahead of the autonomous vehicle 1 in the same lane 3.1. At a distance from the autonomous vehicle 1, there is a target merging gap 9 between the autonomous vehicle 1 and the vehicle driving ahead 5, into which the overtaking vehicle 4 should ideally merge.

FIG. 3 is a schematic view of a roadway 2 with two lanes 3.1, 3.2, wherein the autonomous vehicle 1 drives in lane 3.1 and is being overtaken on the left by an overtaking vehicle 4. In lane 3.1, a vehicle 5 is driving ahead of the autonomous vehicle 1 at a distance. In lane 3.2, an oncoming vehicle 6 is driving in the opposite direction.

The aim is to avoid a collision between the overtaking vehicle 4 and the oncoming vehicle 6. The autonomous vehicle 1 should therefore steer laterally away from the overtaking vehicle 4 and utilize the entire width of its own lane 3.1 so that all three vehicles, i.e. the autonomous vehicle 1, the overtaking vehicle 4 and the oncoming vehicle 6, fit next to each other.

FIG. 4 is a schematic view of a method for operating the autonomous vehicle 1.

In step S1, the autonomous vehicle 1 monitors its environment using its sensors 7 and the computing unit 8. If an overtaking vehicle 4 is detected in a lane 3.2, the relative speed vᵣₑₗ is determined. If this is high enough for an overtaking maneuver, it is concluded that the overtaking vehicle 4 can overtake the autonomous vehicle 1. In this case, in a step S2, the autonomous vehicle 1 monitors the environment for oncoming vehicles 6 in the same lane 3.2 as the overtaking vehicle 4, at least if bidirectional traffic is possible on this lane 2.

If no oncoming vehicle 6 is detected, the driving behavior of the autonomous vehicle 1 is adapted in step S3 so that it adopts a defensive driving style and brakes if necessary to enable the overtaking process.

If an oncoming vehicle 6 is detected, the lateral position of the autonomous vehicle 1 is adjusted in step S4 to make room for the overtaking vehicle 4 so that all three vehicles, i.e. the autonomous vehicle 1, the overtaking vehicle 4 and the oncoming vehicle 6, fit next to each other. Step S3 is then carried out as described above. If it was detected in step S5 that the overtaking vehicle 4 has a trailer, a light signal, for example a headlight flash, can be provided in step S6 as soon as the overtaking vehicle 4 reaches the target merging gap 9 to signal that it is safe to merge.

FIG. 5 is a schematic view of the computing unit 8. Data from the sensor system 7 and data from a satellite navigation system 10 are fed to the computing unit 8. Using this data and the data from a digital map 11, a first module 12 detects an oncoming vehicle 6, a second module 13 detects an overtaking vehicle 4 and its relative speed and a third module 14 analyzes the target merging gap 9. A fourth module 15 can be used to analyze culture-dependent signals from other road users.

Based on the data determined by the modules 12 to 15, a decision is made in step S3, if necessary, to execute a defensive driving maneuver, taking into account the own movement data EB of the autonomous vehicle 1, including its speed v_{ego} and yaw rate. This is taken into account in a behavior planning module 16 in order to control an actuator 17 of the autonomous vehicle 1 for steering, accelerator and brake accordingly.

The culture-dependent signals can be different in different countries and cultures. For example, dim and dip of the headlights in India means that the driver of a vehicle requests the driver of a vehicle in front to let him overtake. Depending on the localization of the autonomous vehicle 1, it can be configured to detect such information and interpret it according to its locally assigned semantics. In this case, the autonomous vehicle 1 can therefore perform a defensive driving maneuver in step S3 as described above.

1. A method for operating an autonomous vehicle, the method comprising:
detecting an environment of the autonomous vehicle using a sensor system, wherein data of the environment is made available to a computing unit, wherein the sensor system detects whether a second vehicle is attempting to overtake the autonomous vehicle;
steering the autonomous vehicle laterally away from the second vehicle when oncoming traffic is detected, thereby creating sufficient space for the second vehicle and the oncoming traffic;
detecting whether the second vehicle intends to overtake the autonomous vehicle;
determining a speed differential between the second vehicle and the autonomous vehicle and
implementing a defensive driving maneuver wherein, the speed of the autonomous vehicle is reduced if the speed differential falls below a predetermined threshold value.

2. The method according to claim 1,
wherein detecting the environment of the autonomous vehicle comprises detecting whether the second vehicle comprises a trailer, wherein a light signal is provided as the second vehicle and the trailer reaches a target merging gap in front of the autonomous vehicle.

3. The method according to claim 1,
wherein detecting whether the second vehicle intends to overtake the autonomous vehicle comprises interpreting culture-dependent signals from the second vehicle that signal an intent to overtake the autonomous vehicle, wherein the autonomous vehicle detects and interprets the culture-dependent signals depending on a localization of the autonomous vehicle.

4. An autonomous vehicle comprising:
a sensor system configured to detect an environment of the autonomous vehicle, wherein the sensor system is configured to detect whether a second vehicle is attempting to overtake the autonomous vehicle; and
a computing unit in electrical communication with the sensor system, wherein the sensor system is configured to provide the data of the environment of the autonomous vehicle to the computing unit,
wherein the autonomous vehicle is steered laterally away from the second vehicle when oncoming traffic is detected, thereby creating sufficient space for the second vehicle and the oncoming traffic,
wherein the autonomous vehicle is configured to determine a speed differential between the second vehicle and the autonomous vehicle,
wherein the autonomous vehicle is configured to implement a defensive driving maneuver wherein the speed of the autonomous vehicle is reduced if the speed differential falls below a predetermined threshold value.

5. The autonomous vehicle according to claim 4, wherein the autonomous vehicle is a commercial vehicle.

6. The method according to claim 2, wherein detecting whether the second vehicle intends to overtake the autonomous vehicle comprises interpreting culture-dependent signals from the second vehicle that signal an intent to overtake the autonomous vehicle, wherein the autonomous vehicle detects and interprets the culture-dependent signals depending on a localization of the autonomous vehicle.
